(19) United States
(12) Patent Application Publication
(10) Pub. No.: US 2013/0314642 A1
(43) Pub. Date: Nov. 28, 2013

(54) NON-BLACK DEAD FRONT DISPLAY

(71) Applicant: CONOPCO, INC., D/B/A UNILEVER, Englewood Cliffs, NJ (US)

(72) Inventors: Kenneth Dykes TIMMERMAN, Huntsville, AL (US); Gregory Kent THOMPSON, Huntsville, AL (US)

(73) Assignee: Conopco, Inc., d/b/a UNILEVER, Englewood Cliffs, NJ (US)

(21) Appl. No.: 13/851,417

(22) Filed: Mar. 27, 2013

Related U.S. Application Data
(60) Provisional application No. 61/650,707, filed on May 23, 2012.

(51) Int. Cl. G09F 13/06; G02F 1/1335

(52) U.S. Cl. CPC G09F 13/06; G02F 1/133512; Y10S 977/774; Y10S 977/95; B82Y 20/00
USPC 349/62; 362/97.1; 977/774; 977/950

(57) ABSTRACT

A non-black dead front display assembly is provided which includes a first plastic layer which in the absence of backlighting is opaque to a viewer, a transparent structural plastic layer, a mask layer with light transparent windows defining at least one graphic, and a support component for supporting a light source for backlighting.

This application claims priority under 35 U.S.C. 119 from U.S. Provisional Application Ser. No. 61/650,707, filed May 23, 2012, and incorporated by reference herein in its entirety.

### BACKGROUND OF THE INVENTION

1. Field of the Invention

The invention concerns dead front display assemblies that operate without necessity of a darkened front panel.

2. The Related Art

Dead front graphics are used in the front-panel and keyboard-overlay industry. “Deadfronting” is a technique referring to a transparent black ink that has been printed behind an open area in a front panel or overlay. Behind the display is a light emitting diode (LED). When energized, the LED lights the display to reveal a symbol or printed message as viewed by an observer from outside the illuminated panel.

There are several benefits of dead front displays. They are visible only when you want them to be. They can conceal a symbol or printed message within a display window, such as a warning light or a caution light that might go unnoticed if the normally transparent graphics were visible at all times. This technique allows the symbols or printed message to blend in with the background. Furthermore, when lit, the graphics attract a viewer's attention and causes them to act only when it is lit. Finally, dead fronts clean up the appearance of a panel and avoid user confusion during operation.

But the known system has limitations. Dead fronts require black or nearly black panels. For many applications, it is aesthetically desirable to have a light colored display panel.

### SUMMARY OF THE INVENTION

A non-black dead front display assembly is provided which includes:
a first plastic layer having outer and inner surfaces, the first plastic layer in an absence of backlighting being opaque to a viewer resultant from diffused reflective light from the outer surface;
a transparent structural plastic layer having a first and second surface the first surface contacting the inner surface of the first plastic layer;
a mask layer with an array of light transparent windows defining at least one graphic and having a front and a rear side, the front side contacting the second surface of the structural plastic layer; and
a support component including a light source for backlighting, the support component arranged behind the rear side of the mask layer.

### BRIEF DESCRIPTION OF THE DRAWINGS

Further advantages and features of the invention become mere apparent from consideration of the following drawings in which:

FIG. 1 is an exploded view of a display assembly as described herein;

FIG. 2 is a schematic cross-sectional view of a display assembly as described herein; and

FIG. 3 illustrates a typical appliance that can utilize the dead front display assembly described herein.

### DETAILED DESCRIPTION OF THE INVENTION

In the prior art, dead front display panels have a dark outer surface. A mask with graphics is placed on top of the outer surface. A viewer's gaze first hits the darkened mask before perceiving the underlying ink darkened transparent plastic. With a careful gaze, the viewer can discern graphics from the mask even without backlighting.

Applicants have found that a darkened substantially black structural plastic support layer is unnecessary. Much lighter colors can be accommodated by the present inventive technology.

In one but not the only embodiment, a mask layer with graphics is interior of the first plastic layer. In fact, the mask layer is separated from the first plastic layer by a transparent structural plastic layer. Consequently, any graphics in a non-backlighted arrangement cannot even dimly be seen. The outer surface of the first plastic layer is homogenous and free of any graphics or graphics bearing mask layer.

The arrangement of the present invention eliminates the need for an outer surface perceived as dark or black by a human viewer. For this reason, a light colored shade of plastic can be employed for the dead front display.

Advantages of this invention in part derive from the first plastic layer being opaque to a viewer through having a diffused reflective surface which creates a perception of color. This contrasts with the black or dark surfaces of the prior art which are non-reflective. Only when lighted from the rear will the first plastic layer allow a percentage of light to transmit therethrough and be perceivable by an outside viewer.

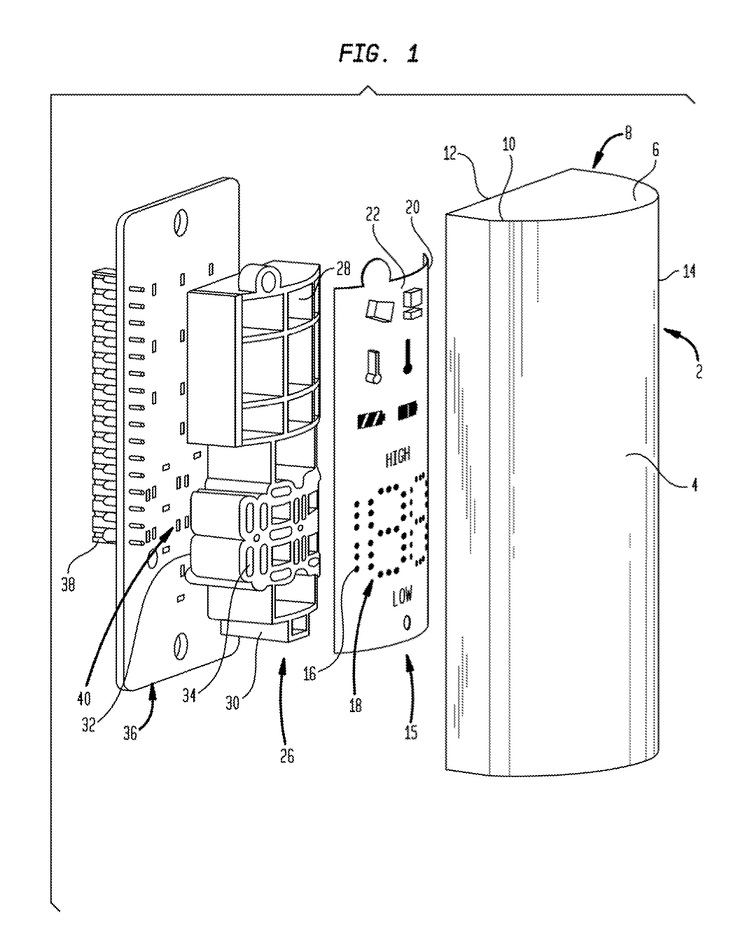

FIG. 1 illustrates in an exploded view elements of a display assembly. Accordingly, the assembly includes a first plastic layer 2 having an outer surface 4 and an inner surface 6. The first plastic layer 2 may be translucent but not transparent when backlighted from the rear; when not backlighted, layer 2 viewed by a human observer from the front will appear opaque because of diffused reflective light from the outer surface 4.

A mask layer 15 features an array of light transparent windows 16 defining at least one graphic 18. A front side 20 and a rear side 22 define the two major surfaces of the mask layer. The front side contacts the second surface of the structural plastic layer.

Graphic 18 may depict a symbol, a numeral, an alphabet letter, a word or combinations thereof. Ordinarily, but not necessarily, the graphic may be composed of pixels which in a grouped arrangement allow a viewer to visualize a symbol, a numeral, an alphabet letter, words and the like. Graphics and their component pixels may be present in any amounts. Their number may range from one to several thousand, sometimes from three to several hundred, other times from four to fifty pixels.

The pixels and their resultant graphics can be formed in a variety of ways on the mask layer. All have in common the formation of a light transparent set of pixel windows. For instance, formation of pixels and thereby the graphic may be achieved by laser etching of a light opaque mask layer. The etching removes pigments or dyes from a transparent film that has been coated with dyed or pigmented paint. Alternatively, the laser may etch pixels in the mask layer by burning apertures directly through the mask layer to create a light transmitting opening. Chemical methods may also be utilized to selectively remove pigments from areas of the mask to create transparent windows that form pixels. Photoresist technology may be utilized for this purpose.

A baffle layer 26 may be present in this embodiment of the display assembly. A plurality of hollow chambers 28 constitute the baffle layer Light opaque walls 30 form the chambers and separate one from another. Each chamber has an open end 32 and an exit end 34. Light is transmitted through the chamber in a direction from the open end to the exit end. The opaque walls of the chamber prevent light from diffusing to other parts of the baffle layer. When assembled, the exit end contacts the rear side of the mask layer.

In a further embodiment, a support component of the display assembly may, but not necessarily, is a printed circuit board 36. The board serves as a support structure for light emitting diodes. In some embodiments the LEDs can be substituted by a liquid crystal display (LCD). Another embodiment may employ nanotechnology having quantum dots to emit light.

The printed circuit board features electrical signal connections 38. A set of light emitting diodes 40 are integrated into the printed circuit board. Each of the LEDs are aligned with one of the chambers of the baffle layer. When assembled, an upper surface 42 of the printed circuit board contacts the open ends of the baffle layer.

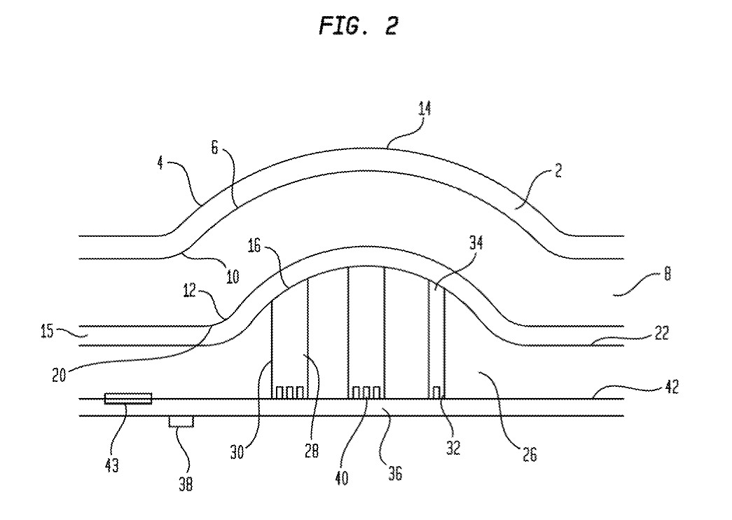

FIG. 2 illustrates in cross-section one type of relationship of components in the display assembly. In this embodiment, curvature exists in the first plastic layer, the transparent structural plastic layer, the mask layer and the baffle layer. Other embodiments may be fully flat rather than have curvature. The printed circuit board preferably is fiat rather than having curvature.

Brightness is modulated by the electrical energy input to an LED. Data storage elements 43 held on the printed circuit board can control electrical energy levels delivered to the LEDs.

The structural plastic layer 8 may typically have a cross-sectional thickness ranging from 0.3 to 20 mm, more typically from 0.3 to 10 mm and sometimes from 0.5 to 3 mm, The first plastic layer 2 ordinarily may have a smaller cross-sectional thickness than that of the structural plastic layer. For instance, the thickness may range from 1 to 50, alternatively from 3 to 20, and possibly from 3 to 10 mil (1 mil=0.0254 mm).

The first plastic layer may be formed of a thermoplastic material such as a polycarbonate. Often this layer is tinted to provide the desired color of the display surface such as a non-black viewer perceived tint. The first plastic layer imparts a glossy finish and luxurious appearance to the display assembly.

A suitable process of manufacturing the display assembly is initially to form the first plastic layer as a skin in a mold. This technology is similar to in-mold label formation. Once this skin of first plastic layer is formed, the mold through an injection molding process receives resin forming the structural plastic layer. The resultant combination then receives the mask layer. Thereafter, the combination is combined with the baffle layer and printed circuit board.

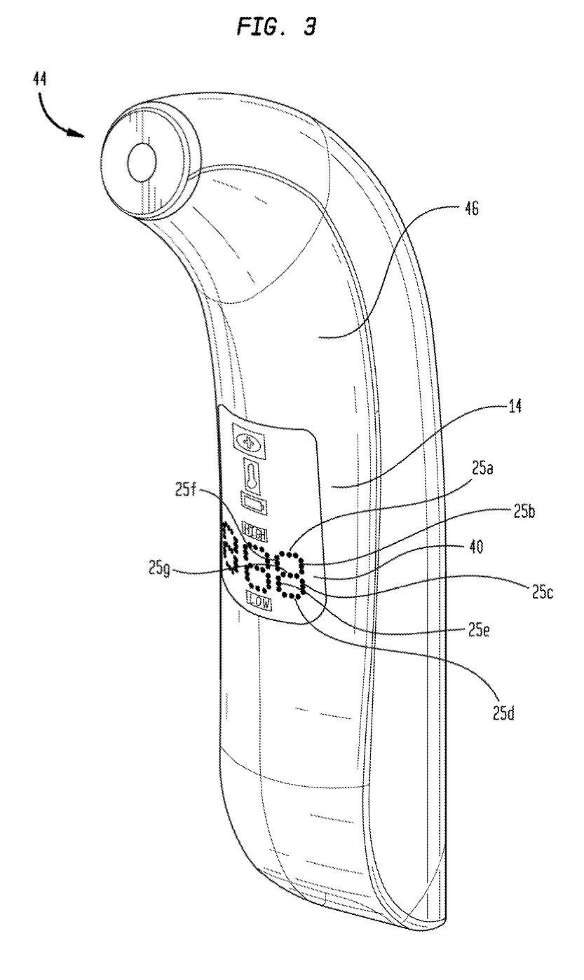

FIG. 3 depicts an appliance device which is a hand-holdable laser 44 that can utilize the dead front display assembly. Housing walls 46 are curved in an area of the display assembly that needs to be viewable. Formation of a numeral through pixels is illustrated on the laser appliance device The numeral “8” is formed with seven separate banks of LEDs. Each bank has a set of three pixels. These banks are represented by 25a, 25b, 25c, 25d, 25e, 25f and 25g.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

What is claimed is:

1. A non-black dead front display assembly comprising:
a first plastic layer having outer and inner surfaces, the first plastic layer in an absence of backlighting being opaque to a viewer resultant from diffused reflective light from the outer surface:
a transparent structural plastic layer having a fiat and second surface the first surface contacting the inner surface of the first plastic layer;
a mask layer with an array of light transparent windows defining at least one graphic and having a front and a rear side, the front side contacting the second surface of the structural plastic layer; and
a support component comprising a light source for backlighting, the support component arranged behind the rear side of the mask layer.

2. The display assembly according to claim 1 wherein the graphic is selected from the group consisting of a symbol, a numeral, an alphabet letter, a word and combinations thereof.

3. The display assembly according to claim 1 wherein the support component is a printed circuit board supporting a plurality of light emitting diodes.

4. The display assembly according to claim 3 wherein the printed circuit board further comprises data storage elements controlling electrical energy levels delivered to the light emitting diodes.

5. The display assembly according to claim 1 wherein the first plastic layer has a smaller cross-sectional thickness than that of the transparent structural plastic layer.

6. The display assembly according to claim 1 wherein the transparent structural plastic layer is formed of polycarbonate.

7. The display assembly according to claim 1 wherein the light source is a liquid crystal display.

8. The display assembly according to claim 1 wherein the transparent structural plastic layer has a cross-sectional thickness ranging from 0.3 to 20 mm.

9. The display assembly according to claim 1 wherein the first plastic layer has a cross-sectional thickness ranging from 3 to 10 mil.

10. The display assembly according to claim 1 wherein the support component is a printed circuit board supporting a plurality of quantum dots to emit light.
